(19) United States
(12) Patent Application Publication
(10) Pub. No.: US 2008/0109275 A1
(43) Pub. Date: May 8, 2008

(54) System and method for remote sales, reporting and inventory management

(75) Inventor: David Baroody, Pembroke Pines, FL (US)

Correspondence Address: MICHAEL J. BUCHENHORNER, 8540 S.W. 83 STREET, MIAMI, FL, 33143, US

(73) Assignee: Flagship Games International, Inc., Hollywood, FL (US)

(21) Appl. No.: 11/594,660

(22) Filed: Nov. 7, 2006

(51) Int. Cl. G06Q 10/00

(52) U.S. Cl. 705/7

(57) ABSTRACT

Briefly, according to an embodiment of the invention a method for remote sales, reporting, and inventory management for a vessel comprises steps or acts of: generating a form comprising voyage information; automatically extracting the voyage information from the form; populating a summary report with the extracted voyage information from the form; and binding the voyage information form the form to the summary report such that a change to the voyage information in the form automatically generates a corresponding change in the summary report. The method also includes receiving an updated summary report from the vessel wherein the receiving step is automatically executed upon the automatic generation of the corresponding change in the summary report. The method additionally includes a step of generating a prompt for conducting an inventory count onboard the vessel.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of remotely managing sales, reporting and inventory management, and more particularly relates to the field of remote sales, reporting and inventory management on board cruise ships.

### BACKGROUND OF THE INVENTION

Controlling remote business functions has long been recognized as an important function of business organizations. However, in the cruise and shipping industries, maintaining business integrity and control is absolutely critical. The possibility of inaccurate and/or fraudulent business practices on board ships is great because there is often not a company representative on board once a ship has left port. A lack of on board storage space, long lead times and shipping costs to remote locations increase the need for accurate and timely management of resources.

The sales, reporting and inventory control processes are generally completed by crew members responsible for the day to day business operations on board the cruise ships. The crew members often do not speak English as their primary language, and must complete these functions in addition to their primary shipboard duties. Many inventory control systems are in use today and these systems, if properly executed can accurately record the sales, reporting and inventory functions. However, because of the complexity of these systems, the information is often recorded incorrectly or is missing important information resulting in unreliable data, inaccurate reporting and false business assumptions. The remote sales, reporting and inventory functions must be completed timely and accurately. Remote sales, reporting and inventory is a daunting task and the present technologies fall short of delivering an accurate, up-to-date, secure sale, reporting and management system.

Therefore, there is a need for a system to overcome the shortcomings of the prior art.

### SUMMARY OF THE INVENTION

Briefly, according to an embodiment of the invention a method for remote sales, reporting, and inventory management for a vessel comprises steps or acts of: generating a form comprising voyage information; automatically extracting the voyage information from the form; populating a summary report with the extracted voyage information from the form; and binding the voyage information form the form to the summary report such that a change to the voyage information in the form automatically generates a corresponding change in the summary report. The method also includes receiving an updated summary report from the vessel wherein the receiving step is automatically executed upon the automatic generation of the corresponding change in the summary report. The method additionally includes a step of generating a prompt for completing a manual inventory count onboard the vessel. This inventory count is used to confirm the inventory count held in the shore-side system.

A system for monitoring and managing remote sales, reporting and inventory for a vessel includes a memory comprising a database; a network interface; and a processor configured for executing program code to execute the method steps. The system also includes at least one data entry terminal and at least one point-of-sale terminal.

A computer readable program product includes program instructions for carrying out the method steps as stated above.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a simplified depiction of the remote Bingo Management System, according to an embodiment of the present invention.

FIG. 2 is a simplified block diagram of the dual functionality of the Bingo Management System, according to an embodiment of the present invention.

FIG. 3 is an exemplary illustration of a Voyage Report showing the inclusion of the Bingo Summary Report, according to an embodiment of the present invention.

FIG. 4 is an exemplary illustration of a Bingo Summary Report, included as part of the Voyage Report of FIG. 3, according to an embodiment of the present invention.

FIG. 5 is an exemplary illustration of an Export Voyage Data graphical user interface screen, according to the known art.

FIG. 6 is a flowchart illustrating a remote inventory control process, according to an embodiment of the present invention.

FIG. 7 shows an automatic reminder generated by the Bingo Manager onboard the vessel, according to an embodiment of the present invention.

FIG. 8 is a high-level block diagram of a computer system configured to operate according to an embodiment of the present invention.

FIG. 9 is an End of Voyage Report graphical user interface screen showing the updated and improved End of Voyage procedures, and in particular highlighting the automated General Tab, according to an embodiment of the present invention.

FIG. 10 is an End of Voyage Report form highlighting the automated Advanced Tab as part of the new End of Voyage Report, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a system and method for conducting sales, managing inventory and creating reports at a remote site, which will be presented in detail here below. The key aspects of the system are: 1) a cashless sales process; 2) automatic inventory prompting; and 3) ease of use with graphical user interfaces, automatic data population and automatic updating and reporting. Although the method as described herein can be useful in many different areas, for simplicity and clarity, we restrict our discussion to the process of operations for oceangoing vessels. This is because the complexity of managing sales, reporting and inventory for oceangoing vessels is something that is readily apparent and easily understood. Additionally, we use examples of reports focusing on onboard gaming, in particular Bingo.

The method begins by establishing parameters for each voyage, including but not limited to, types of products and pricing information. The information is transmitted electronically to the remote site (the ship), where it is introduced into the remote portion of the system. An electronic interface generated by the system allows for the introduction of information pertaining specifically to the voyage and/or the reporting period. The process of selling, reporting and managing inventory as per the system parameters ensue for the duration of the reporting period (length of voyage). Upon conclusion of the reporting period, reports are generated at the remote site with sales and inventory information which populates additional reports with the data resulting both from business activities, and from user input, then binding the information to reports, which are transferred to shipboard personnel and transmitted to the remote site.

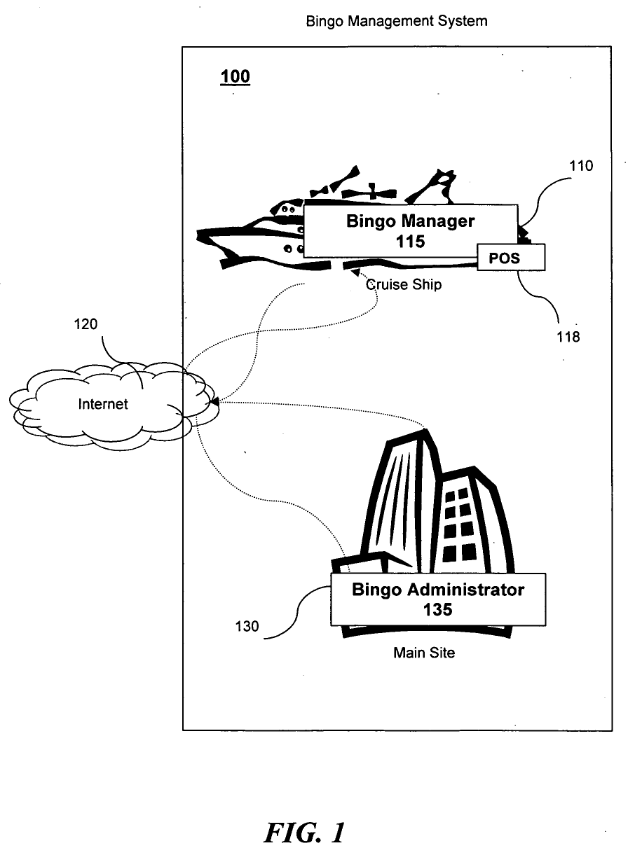

Referring now in specific detail to the drawings, and particularly FIG. 1, there is shown a depiction of a Bingo Management System, according to an embodiment of the present invention. For the purpose of this application, this process will refer to the reporting period as a “Voyage,” two of the reports as the “Voyage Report” and the “Summary Report,” and the procedure for reporting at the end of the reporting period as the “End of Voyage Procedures.” In addition, the portion of the system residing at the main site 130 and managed by shore side personnel shall be known as the “Bingo Administrator,” 135 and the portion of the system operating at the remote site 110 as the “Bingo Manager” 115. The client or remote site 110 shall be referred to as the “ship.”

The functions of the Bingo Administrator 135, Bingo Manager 115, and Bingo POS (point of sale) terminals 118 are collectively known as the Bingo Management System (BMS) 100. The system utilizes the Bingo Administrator 135 to set parameters for each client and/or ship 110, transmit these parameters to the ship 110, conduct business activities on behalf of the client including sales, reporting and inventory control, and transmit the data in various forms to the shipboard personnel and Bingo Administrator 135. These functions include the ability to automatically perform functions without input from an operator on board the ship 110. Such functions include but are not limited to a method of automatically transferring information to additional reports such as from the Voyage Report to the Summary Report, a method including receiving a prompt to complete the inventory, and completion of the End of Voyage process and reporting at the remote site 110 which is then transmitted electronically to the Bingo Administrator 135.

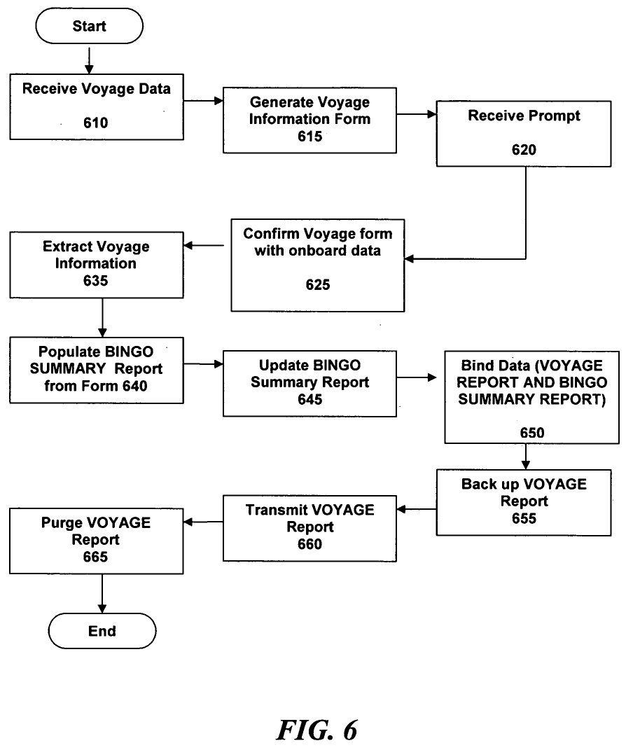

Referring now to FIG. 6, there is shown a flowchart 600 of the BMS 100 process according to an embodiment of the invention. The process begins at the beginning of a voyage. Voyage data, such as the voyage data shown in the Voyage Report is entered onto a disk at the main site 130 in step 610. The voyage data is stored at the main site 130, but it is also transferred to the ship 110. The voyage data may also be stored on a secure website where operators on board the ship 110 will have limited access. Note that “operator” will be used to refer to any persons on board the vessel 110 with the responsibility of completing the sales, reporting or inventory management functions. This voyage data is entered into the system for the purpose of conducting operations and completing reporting for the reporting period and input into the Voyage Report Form 300 in step 615. The voyage reporting function must be completed at the start of every voyage, updated throughout the voyage, and completed at end of the reporting period.

At some point during the voyage shipboard personnel will receive a prompt in step 620 to conduct a manual inventory. The data gathered from this process will be used to confirm the inventory information from the Voyage Report Form 300 in step 625. Data from the Voyage Report Form 300 will be extracted automatically in step 635 by the system to populate the Bingo Summary Report Form 400 in step 640. The Bingo Summary Report 400 is updated in Step 645. Data from the Voyage Report 300 is bound to the Bingo Summary Report 400 so that a change in Voyage data will automatically be reflected in the Bingo Summary Report 400 in step 650. The Voyage Report 300 is backed up in step 655 and transmitted to the main site 130 in step 660. Once an acknowledgement is received from the main site 130 that the report was successfully transmitted, it can be purged in step 665.

The Bingo Management System (BMS) 100 includes three modules as described here below, a Bingo Administrator 135, Bingo POS System 118, and a Bingo Manager 115.

Bingo Administrator 135: this is the shore side 130 software to manage the system and database. This software resides at a secure location 130, generally at the business headquarters. The Bingo Administrator 135 generates the parameters for transmission to the ships, and receives and stores information from the ships.

Shore Side Administration completes the functions below:

1) Sets parameters for each cruise line, and each ship, such as: types of games available; types of products available (Bingo cards); price of products;

2) loads the parameters onto the Shipboard Bingo Manager System 115. This system generated file may be transported by shore side personnel to the vessel 110 for installation into the software, or the shore side site 130 may transmit the software via the Internet 120 as an electronic file to be loaded by shipboard personnel. The encrypted system files may be transmitted via email using any commonly available email protocol, such as IMAP (Internet Message Access Protocol), POP3 (Post Office Protocol 3), or SMTP (Simple Mail Transfer Protocol). The data may also be transmitted as an update or an upload to a website, or through FTP (File Transfer Protocol). The Bingo Administrator 135 consists of this shore side module and two additional systems located on the ships.

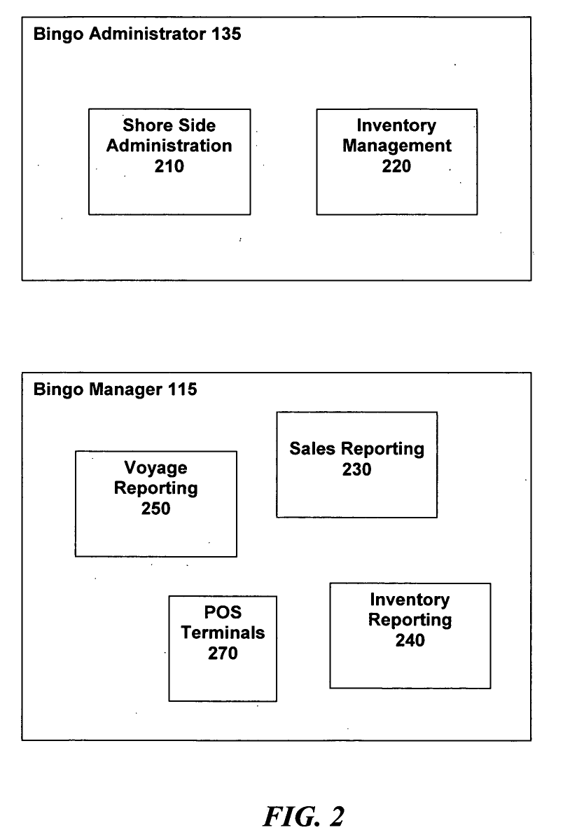

Referring now to FIG. 2 there is shown a simplified block diagram illustrating the separation of functionality between the shore side module and the ship board systems. The Bingo Administrator 135 comprises functionality for shore side administration 210 and inventory management 220. The ship board functionality includes:

The Bingo POS System 270 which includes tools and processes for cashless sales including use of a touch screen system; Sales Reporting 230, Inventory Reporting 240 and Voyage Reporting 250.

Bingo Manager System (BMS) 115 is application software to manage Bingo operations on cruise ships 110, according to an embodiment of the present invention. The key features of this system are as below.

1) The collection and utilization of data from the Bingo Administrator 135, and as a result of sales and bingo business transactions,

2) Capturing and summarizing sales transactions from the Bingo POS System 270,

3) Performing calculations for sales, revenue, payouts and snowball jackpot;

4) An inventory module 240 that ensures a series of Bingo cards and other supplies are held in the system available for sale. The inventory module 240 assures that, once removed from inventory during the sales process, a Bingo card is considered “active” and can win prizes during Bingo games by the process as: Paper Bingo cards are serialized and the Bingo Administrator 100 prepares an electronic file to correspond to Bingo cards for each order. This electronic inventory file is loaded on the onboard Bingo Manager 115. As cards are sold at POS terminals 270, they must be in inventory to be considered a valid card to play and or win at Bingo. The Bingo Manager 115 collects and transmits to the Bingo Administrator 135 information regarding the product sales, including product type, product price, a number used as complimentary and no charge sales dollar amounts. Optionally, a stand alone MS Excel file that is stored on the shipboard computer can be completed after a manual inventory count to confirm adequate levels of inventory. The report is filled out for the period (currently monthly) and the file is transmitted electronically (currently via e-mail) to the shore side facility 130 for fulfillment.

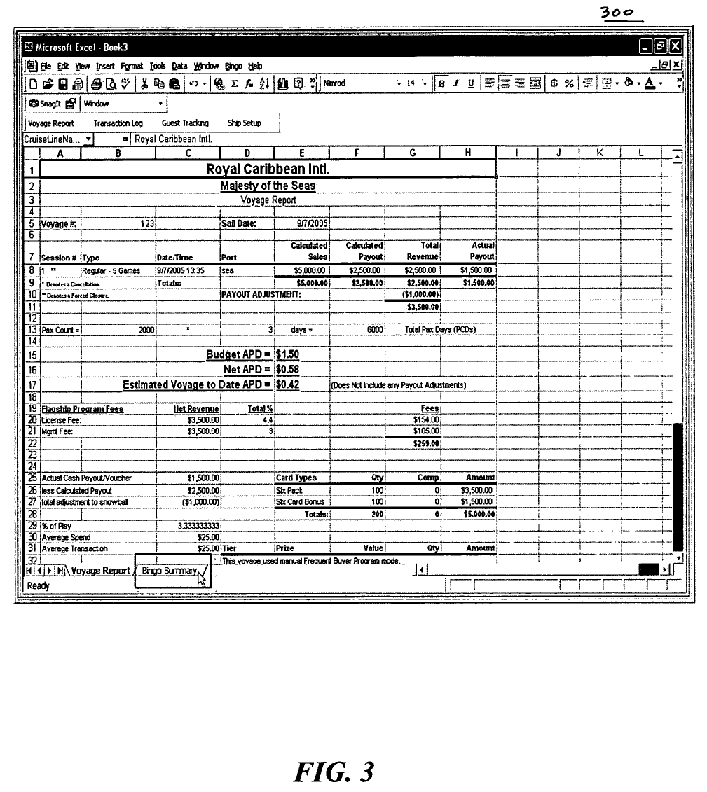

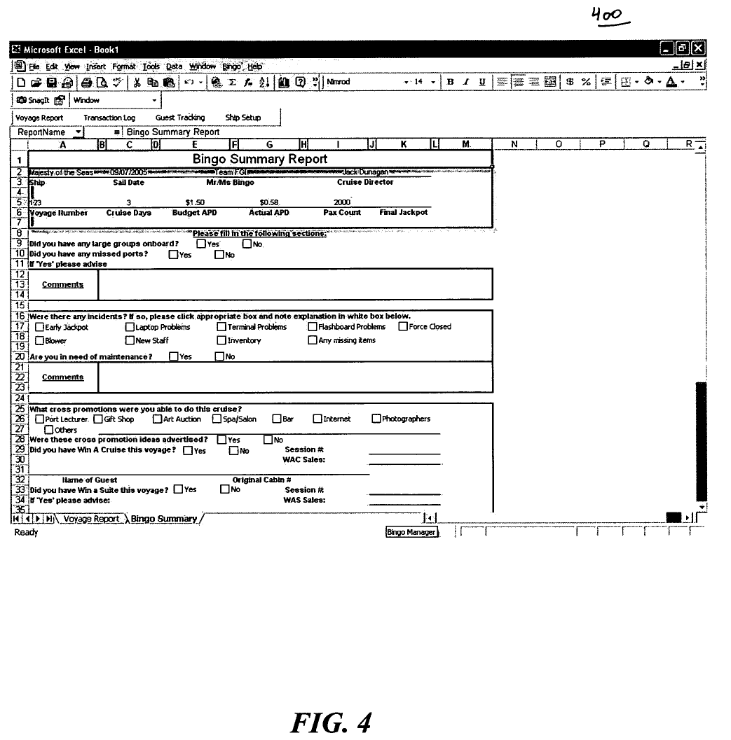

5) Voyage Reporting 250: including a Voyage Report 300 with numerical and non-numerical information from the Summary Report. There are in addition to the Voyage and Summary reports as shown in FIG. 3 and FIG. 4, various reporting mechanisms within the Bingo Manager System 115 to report on activities within the voyage. Voyage duration is usually three to ten days.

FIG. 3 shows a Voyage Report form 300. This form is an example of a printed for visual form used to transmit information to shipboard personnel or the Bingo Administrator site. 130. Note that because the Voyage Report 300 may contain sensitive data pertaining to passengers and crew members, it is a restricted form. This means that although an operator can enter some data into the form, not all of the form fields are viewable to the operator. This is an example of the separation of critical and non-critical information for remote sales, reporting and inventory management. The secure site 130, handles all of the critical information, while the operators are responsible for the non-critical information, such as supplies and sales. In one embodiment of the present invention, the Report 300 is received at the secure site 130 and kept in the database to facilitate administrative business functions including compliance and auditing functions. The operators do not see all portions of the reports, nor are changes allowed to all areas. The secure site 130 handles any updates to the reports 300. The information contained in the reports 300 can also be used for generating other reports at the secure site 130. The report 300 data can be used for equipment reporting, service reporting, and so forth. Restricting access to the database 890 is another method of controlling access to any sensitive data on the forms.

In case of an onboard discrepancy or emergency, the information in the Voyage Report 300 may be requested by shipboard personnel or law enforcement officers. As is readily apparent, it is important, and may also be required by law, for cruise lines to keep complete control of key administrative functions at secure sites, away from the vessels. Shipboard personnel are only allowed controlled access to shipboard functions. This is done not only for the safekeeping of the sensitive data, but for the protection of the shipboard personnel as well. The secure site 130 is responsible for validating the information transmitted back and forth from the vessel 110.

Summary Report Information FIG. 4 shows a Bingo Summary Report 400, according to an embodiment of the present invention. This is an example of one of many forms used to track sales, inventory and other information on board a vessel in order to better predict business requirements for future voyages. Unlike known reports which are completed outside of the system, this Report 400 is now generated by the system 100 and automatically bound to the Voyage Report 300. Portions of the Summary Report 400 are automatically filled in from the Voyage Report 300. This greatly reduces errors and omissions compared to the prior method.

Automatic System Generation of the Summary Report. During the completion of the End of Voyage procedures, the Bingo Summary Report 400 and End of Voyage Report are generated by the Bingo Management System 100. These reports were formerly completed outside of the Bingo Management System 100 for completion in full by the shipboard operators. This allowed for erroneous input and included an additional step of transmitting the Summary Report 400 to the secure site 130. The system generated Summary Report 400 is bound to the Voyage Report 300 and includes information pulled from the system where applicable to ensure reliability of information, ease of completion and submittal, and inclusion into the backup of the system generated reports, and added security as transmission is included in the system generated reports which are encrypted for submission.

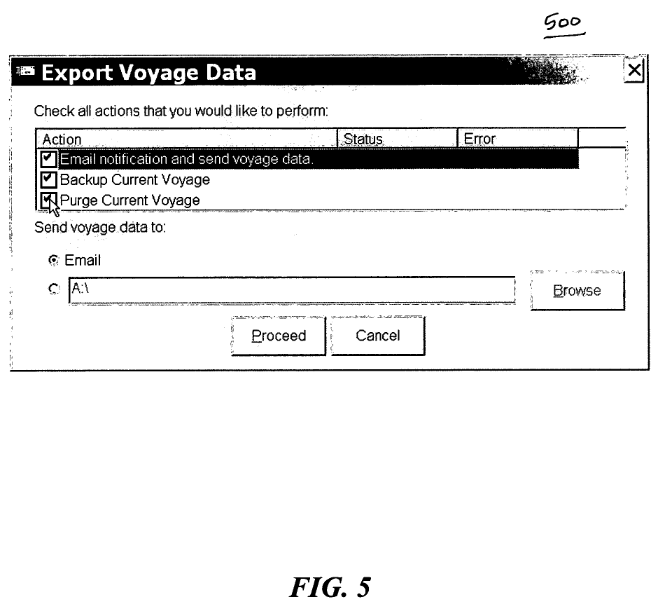

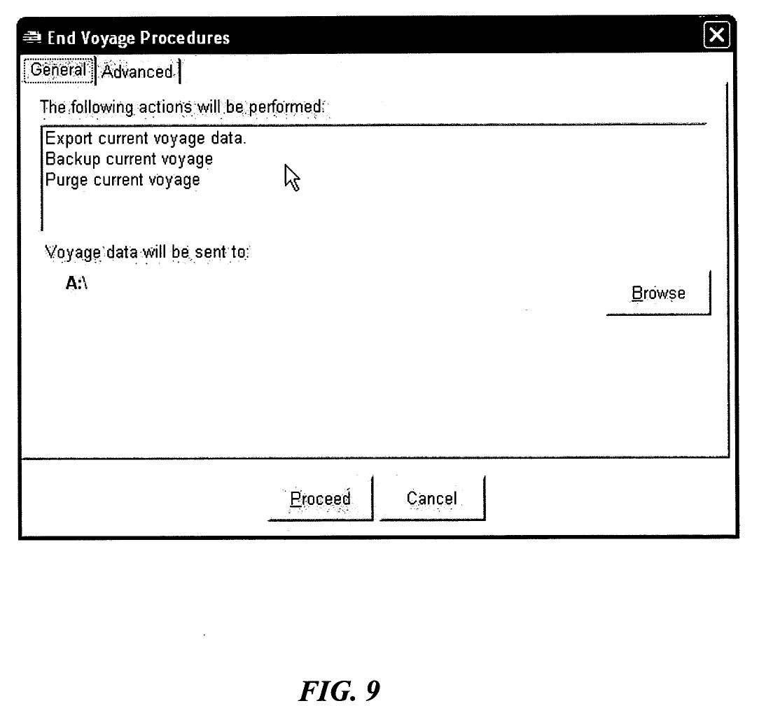

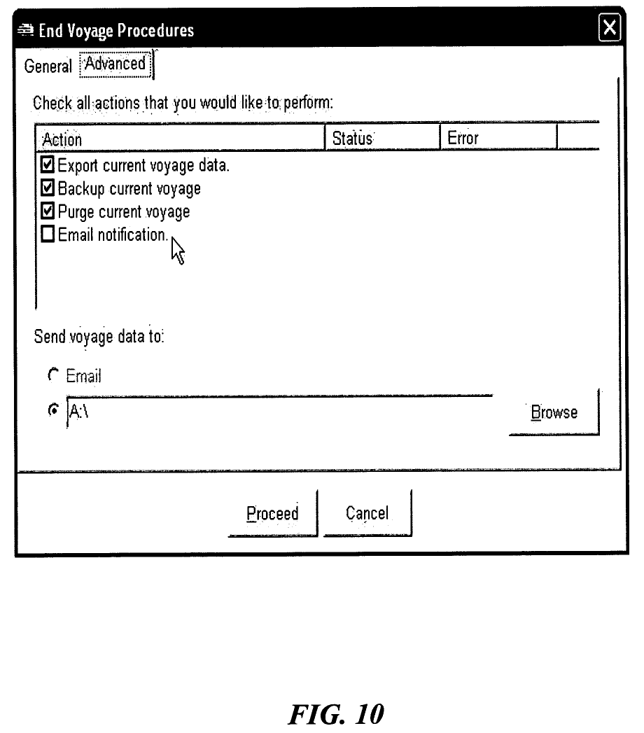

End of Voyage Procedures. Referring now to FIG. 5 there is shown a End of Voyage Report Form 500 for completing the Voyage Reports, according to the known art. The reporting includes but is not limited to all of the data relating to the ship, the voyage, and the passengers. Some of the data fields are: vessel number, voyage name, voyage dates, ports visited, passenger information, crew information, and sales and revenue information. One of these fields is a key field, meaning that it is used as a unique identifier for this particular voyage. Each voyage has its own unique report 300. In the BMS 100 according to an embodiment of the present invention the End of Voyage Report Form as illustrated in FIGS. 9 and 10 now has auto-generated fields which eliminate operator errors which were problematic with the known report form 500.

The Reports 300 are created by the shipboard Bingo Manager System 115 and are provided in two formats, one for viewing and printing by ship board personnel, and one for automated transmittal to the shore side Bingo Administrator 135. A key feature added to the End of Voyage Procedure process is the facilitation through the use of Tabs, as shown in FIGS. 9 and 10. These tabs automatically default to specifications to reduce the amount of input by operators. This ensures accurate reporting and adherence to procedures including a step to back up the reports in step 655. This backup may be kept on board for reference in case of a system failure.

In FIG. 9 the “General” tab is selected. FIG. 9 shows three functions selected by default and also shows the target destination for the voyage data. This eliminates the possibility that an operator will make any erroneous selections and/or mistakenly omit a needed selection, as compared to the fill able fields as shown in FIG. 5.

FIG. 10 shows the “Advanced” tab selected. This tab is available for future system changes that will allow the voyage data to be emailed directly from the remote Bingo Manager 115 to the Bingo Administrator 135. At that time, the operator will be allowed to choose the function of “Email notification.” The other functions are defaulted, but can be unselected if they are not needed. This gives the Bingo Management System 100 the opportunity to use the same proprietary software in an environment that may have different hardware equipment and/or a different protocol for transmitting the necessary electronic files. By pre-selecting the default fields in the General and Advanced Tabs, the Bingo Manager 135 can easily modify the form to keep up with system changes, yet mask those changes so that they are transparent to the operator.

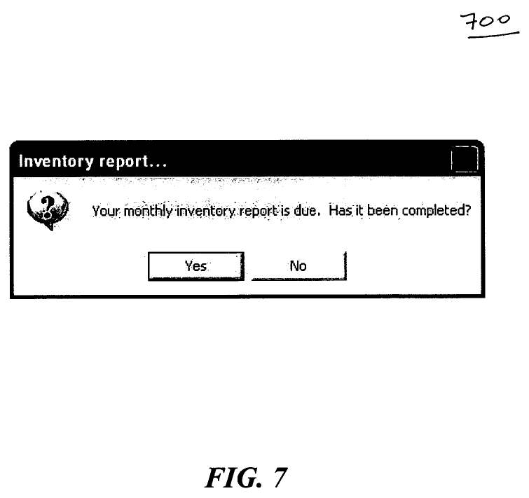

Referring to FIG. 7, there is shown an exemplary illustration of the automated inventory prompt 700 according to an embodiment of the present invention. The Bingo Management System 100 does not report to the ship the status of the onboard inventory. While this information is available through the reporting function through the Bingo Administrator 1 15, onboard staff are required to periodically perform a manual inventory count, complete an order form and submit to the shore side personnel for fulfillment. The Bingo Management System 100 makes use of user-friendly GUIs (graphical user interfaces) common to many software applications. To ensure the inventory process is completed in a timely manner, an automated prompt has been programmed into the software. This new prompt ensures that inventory procedures will be performed in a timely manner. This process of manual counting and submittal of orders by shipboard personnel provide a confirmation of the inventory levels held in the Bingo Administrator 115.

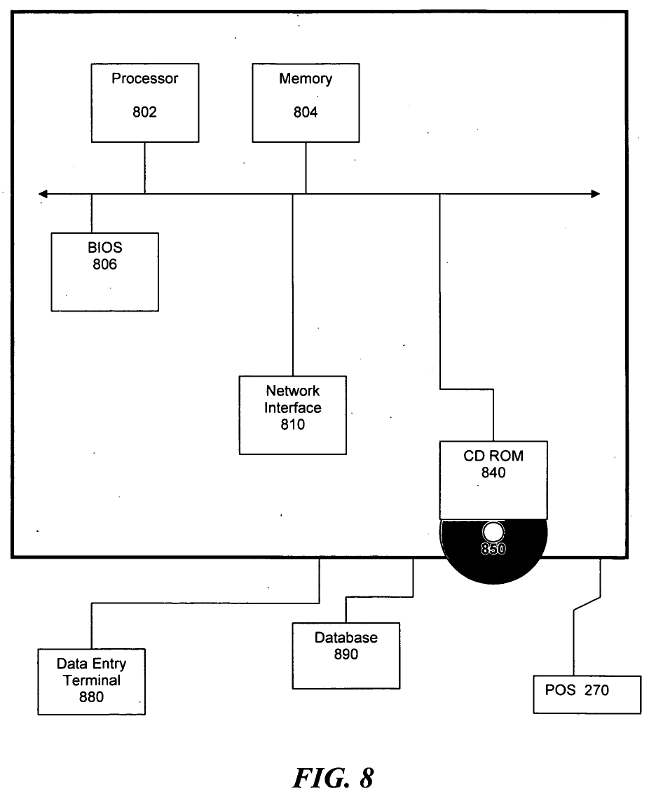

Referring to FIG. 8, there is shown a block diagram of an information handling system 800 configured to operate according to an embodiment of the present invention. The system 800 is configured for managing the remote sales, reporting and inventory functions at a remote site. The system 800 comprises a processor 802, a memory 804, and an input/output (I/O) subsystem 806. The processor 802 may be a general or special purpose microprocessor operating under control of computer program instructions executed from a memory. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that performs their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. A network interface 810 is for accessing a local area network, and/or a wide area network such as the Internet 120.

The memory 804 may be partitioned or otherwise mapped to reflect the boundaries of the various memory subcomponents. The memory 804 represents either a random-access memory or mass storage. It can be volatile or non-volatile. The system 600 can also comprise a magnetic media mass storage device such as a hard disk drive. Processor and memory components are physically interconnected using a conventional bus architecture.

The I/O subsystem 806 may comprise various end user interfaces such as a display, a keyboard, and a mouse. The I/O subsystem 806 may further comprise a connection to a network such as a local-area network (LAN) or wide-area network (WAN) such as the Internet. Additionally, at least one data entry terminal 880 may be connected to the system 800 via a wireless connection. The data entry terminal 880 may be a handheld device. A CD/DVD ROM drive 840 for use with a disc 850 is also supported in system 800. The system 800 is also operatively connected to a database 890. A POS system 270 is also operatively connected to the system 800. What has been shown and discussed is a highly-simplified depiction of a programmable computer apparatus. Those skilled in the art will appreciate that other low-level components and connections are required in any practical application of a computer apparatus.

The method can also be implemented as machine executable instructions executed by a programmable information processing system or as hard coded logic in a specialized computing apparatus such as an application-specific integrated circuit (ASIC).

Therefore, while there has been described what is presently considered to be the preferred embodiment, it will understood by those skilled in the art that other modifications can be made within the spirit of the invention.

We claim:

1. A computerized method for remote sales, reporting and inventory management for a vessel, the method comprising steps of:
generating a form comprising voyage information;
automatically extracting the voyage information from the form;
populating a summary report with the extracted voyage information from the form; and
binding the voyage information from the form to the summary report such that a change to the voyage information in the form automatically generates a corresponding change in the summary report.

2. The method of claim 1, further comprising a step of:
receiving an updated summary report from the vessel.

3. The method of claim 2, wherein the receiving step is automatically executed upon the automatic generation of the corresponding change in the voyage report.

4. The method of claim 2, wherein the receiving step comprises receiving an email transmission with the updated summary report from the vessel.

5. The method of claim 1, wherein the voyage information comprises:
passenger names;
crew names;
dollar amounts of sales;
dates of voyage;
passenger counts; and
a unique identifier for the voyage.

6. The method of claim 1 further comprising a step of selecting data in the summary report by accepting pre-selected data fields presented as default selections.

7. The method of claim 2 wherein the receiving step is further executed upon completion of the summary report.

8. The method of claim 1 further comprising a step of:
generating a backup of the summary report.

9. The method of claim 1 further comprising a step of:
purging the summary report from a database.

10. The method of claim 9 wherein the summary report is automatically purged from the database upon notification that end of voyage procedures are completed.

11. A computerized method for remote sales, reporting and inventory management on board a vessel, the method comprising steps of:
generating an automatic prompt indicating that inventory procedures should be executed; and
receiving an inventory count from inventorying conducted on board the vessel as part of the inventory procedures.

12. The method of claim 11 wherein the automatic prompt is generated monthly.

13. The method of claim 11 further comprising a step of:
confirming that a system-generated inventory count is correct by comparing it to the inventory count conducted on board the vessel.

14. The method of claim 11 wherein the automatic prompt is a graphical user interface screen.

15. An information processing system for monitoring and managing shipboard operations for a vessel, comprising:
a memory comprising a database;
a network interface; and
a processor operatively connected to the memory and the network interface, the processor configured for executing program code, wherein the program code enables the processor to:
receive voyage data;
store the voyage data in the database;
send a prompt to a user to update an inventory count;
populate the summary report with the voyage data;
bind the voyage data from the database to the summary report such that a change in the voyage data automatically generates a corresponding change in the summary report;
store the summary report in the database; and
transmit the summary report to a remote location.

16. The system of claim 15 wherein the program code further enables the processor to generate a backup of the summary report.

17. The system of claim 16 wherein the backup is stored at the remote location.

18. The system of claim 15 wherein the program code further enables the processor to purge the summary report from the database.

19. The system of claim 15 further comprising at least one data entry terminal.

20. The system of claim 15 further comprising at least one point-of-sale terminal.

21. A computer readable medium comprising program instructions for:
generating a form comprising vessel information;
automatically extracting the vessel information from the form;
populating a summary report with the extracted vessel information;
binding the vessel information from the form to the summary report such that a change to the vessel information in the form automatically generates a corresponding change in the summary report; and
transmitting the summary report to a remote site.

22. The computer readable medium of claim 21 further comprising program instructions for:
generating an automatic prompt indicating that inventory procedures should be executed.

23. The computer readable medium of claim 21 further comprising program instructions for:
selecting data in the summary report by accepting pre-selected data fields presented as default selections.
